(19) United States
(12) Patent Application Publication
(10) Pub. No.: US 2006/0017417 A1
(43) Pub. Date: Jan. 26, 2006

(54) Electronic startup device for hermetic compressors

(76) Inventor: Mario Luis Botega JR., Sao Carlos (BR)

Correspondence Address: CHRISTIE, PARKER & HALE, LLP, PO BOX 7068, PASADENA, CA, 91109-7068, US

(21) Appl. No.: 11/188,208

(22) Filed: Jul. 21, 2005

(30) Foreign Application Priority Data
Jul. 23, 2004 (BR) PI 0403060-5

(51) Int. Cl. H02P 1/42

(52) U.S. Cl. 318/786

(57) ABSTRACT

An electronic startup device and a method of using it for single phase induction motors, such as those used in hermetic compressors, and permanent capacitor motors may save energy by eliminating energy consumption after the startup period of the motor. The electronic startup device may comprise a circuit including a unidirectional electronic switch which connects a start winding of an induction motor to an alternating voltage source through a thermistor or a solid state pill, which defines the starting time of the motor, and to a full wave rectifier. A timing circuit may activate the unidirectional electronic switch disconnecting the thermistor from the rest of the circuit during an adjustable turning off time.

### CROSS-REFERENCE TO RELATED APPLICATIONS

This application claims priority of Brazilian Patent Application Number PI 0403060-5, filed on Jul. 23, 2004, the entire content of which is incorporated herein by reference.

### BACKGROUND OF THE INVENTION

This invention relates generally to the field of single phase induction motors, more specifically to the startup of this type of motors, and to the application of startup devices in hermetic compressors.

Hermetic compressors used in refrigeration often include single phase induction motors because single phase induction motors are robust and easy to construct.

In low capacity refrigeration applications, for example in residential applications, these single phase induction motors are comprised of a rotor and a stator. The stator, in turn, is composed of a start winding, or auxiliary (SW), and a run winding (RW).

Depending on the internal temperature of a refrigerator cabinet, its compressor is periodically activated by a thermostat (T1). When the compressor is activated, its start (SW) and run (RW) windings connect to a power source for the duration of a certain period of time that is called the starting time (or startup time) (TP). The power source may be the city electrical power network, an electrical power generator, or the like.

During this period of starting time (TP), the currents that flow through the start (SW) and run (RW) windings are electrically displaced to assure the generation of electromagnetic torque during startup. After this starting period, the start winding (SW) is disconnected from the power source while the run winding (RW) remains connected to the power source.

However, in the case of compressors using permanent capacitor motors, the start winding (SW) also remains connected to the power supply through the permanent capacitor. To disconnect the start winding (SW) after starting time (TP) different types of devices, for example, devices based on thermistors with positive temperature characteristics (PTC or PTC relay) may be used.

In a conventional startup device that incorporates a thermistor, such as a PTC pill, the PTC thermistor (PTC) is placed in series with the start winding (SW). Then, the electrical current flowing through the start winding (SW) will also flow through the PTC thermistor (PTC), heating the thermistor, and causing the electrical resistance of the thermistor to increase which will cause the current passing through it to decrease. At some point, the current passing through the start winding (SW), that is connected in series with the PTC thermistor (PTC), becomes so small so as to practically turn the start winding (SW) off.

The startup system, described above, has the advantage of simple construction and use. This system, however, suffers the principal disadvantage of relatively high energy consumption. For example, after starting time (TP), the thermistor continues consuming electrical energy as long the compressor motor is in operation. In a typical system, this thermistor may consume approximately 2 Watts of energy. Such energy consumption may present a relatively significant problem in systems where energy efficiency is important. Accordingly, a need exists for an improved startup system for single phase induction motors.

### SUMMARY OF THE INVENTION

In view of the above shortcomings and with the goal of overcoming them, the electronic startup device of this invention and a method of using the device were developed.

In some embodiments the electronic startup device is incorporated into hermetic compressors.

In some embodiments the electronic startup device is incorporated into a single phase induction motor, including a single phase induction motor with permanent capacitor.

In some embodiments the electronic startup circuit presented here achieves low energy consumption after a startup period or a starting time of the motor by eliminating PTC thermistor (PTC) energy consumption. Disconnecting the PTC thermistor (PTC) from the power supply may be achieved in some embodiments partly by the use of a unidirectional electronic switch (S1) as the PTC thermistor (PTC) interconnection element to the single phase motor.

In some embodiments an electronic startup device for single phase induction motors incorporates an electronic switch connecting the start winding to the power source during a determined period of time. This period may be defined by an electronic control circuit, which turns on and turns off the referred electronic switch.

One advantage of an electronic device constructed in accordance with the invention may relate to the energy consumption in steady state (the term “steady state” as used here refers to the system after the startup time has ended). Here, the energy consumption of the electronic device may be substantially less than that of conventional devices that use only the solid state pill with positive temperature coefficient PTC.

Another advantage of an electronic device constructed in accordance with the invention may be that the PTC disconnection time is shorter the greater the supply voltage is and vice versa. That is, in situations where the supply voltage is smaller, the disconnection time is longer, since the PTC takes more time to warm up. With this characteristic, the startup of the compressor may be assured since the PTC may only by disconnected after the startup.

In some embodiments an electronic startup device incorporates a unidirectional electronic switch including, for example, although not limited to, an SCR, a bipolar transistor, a MOSFET type transistor, an IGBT type transistor, and others, for the turning on and off control of the PTC pill and, consequently, of the startup circuit.

The use of these electronic devices of this invention with startup capacitor and with permanent capacitor may constitute another advantage.

Lastly, besides the abovementioned characteristics, an electronic startup device constructed in accordance with the invention may use few components, there facilitating the production of the device, and also providing a device with smaller dimensions.

### BRIEF DESCRIPTION OF THE DRAWINGS

These and other features, aspects and advantages of the present invention will be more fully understood when considered with respect to the following detailed description, appended claims and accompanying drawings, wherein:

FIG. 1 illustrates, in a simplified form, one embodiment of interconnection of an electronic startup device with a compressor motor;

FIG. 2 illustrates a simplified electrical circuit of one embodiment of an electronic startup device and its interconnection with a compressor motor;

FIG. 3 illustrates a typical waveform related to one embodiment of the electronic circuit, showing current and voltage behavior during the starting time and after this time during steady state; and

FIG. 4 illustrates another typical waveform of the voltage during the starting time and after startup during steady state.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus or method. Finally, like reference numerals denote like features throughout the specification and figures.

### DETAILED DESCRIPTION OF THE INVENTION

The invention is described below, with reference to detailed illustrative embodiments. It will be apparent that the invention may be embodied in a wide variety of forms, some of which may be quite different from those of the disclosed embodiments. Consequently, the specific structural and functional details disclosed herein are merely representative and do not limit the scope of the invention.

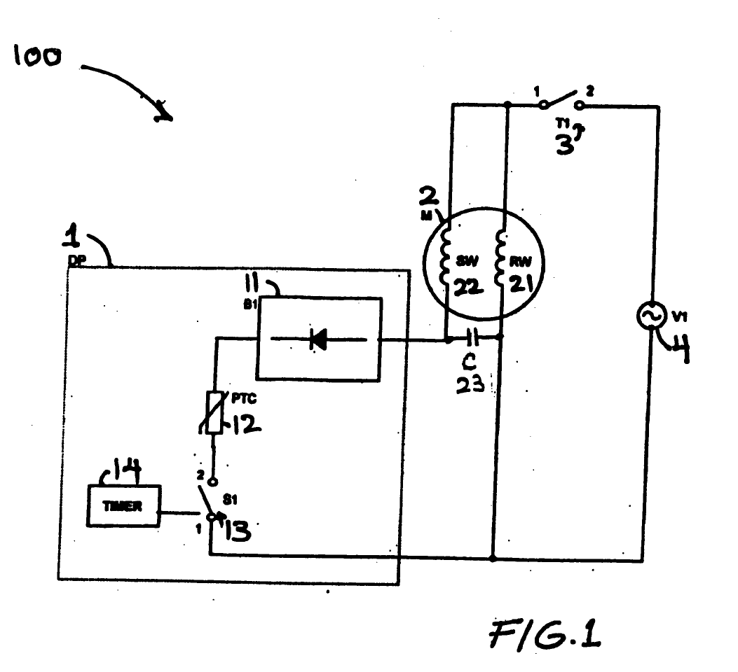

FIG. 1 is a diagram showing one embodiment of an interconnection of an electronic startup device (DP) 1 with a single phase induction motor such as a compressor motor (M) 2, a thermostat (T1) 3 and an alternating voltage source (V1) 4, all interconnected to form a system 100. The alternating voltage source (V1) 4 supplies the run winding (RW) 21 and the start winding (SW) 22 of the motor (M) 2 of a hermetic compressor. A run capacitor (C) 23 is coupled between the run winding (RW) 21 and the start winding (SW) 22.

The electronic startup device (DP) 1 includes a rectifier circuit (B1) 11 connected to a PTC thermistor (PTC) 12 which is in turn connected to an unidirectional electronic switch (S1) 13 which is driven by a timing circuit (Timer) 14.

During startup, the contact of thermostat (T1) 3 closes, causing the unidirectional electronic switch (S1) 13 to also “close”, connecting the start winding (SW) 22 of motor (M) 2 to the alternating voltage source (V1) 4.

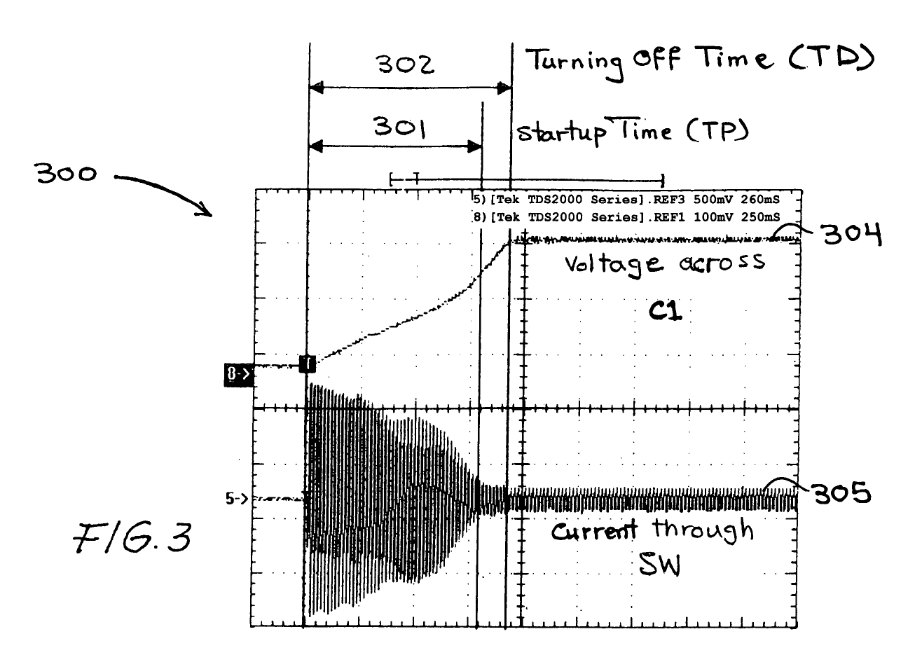

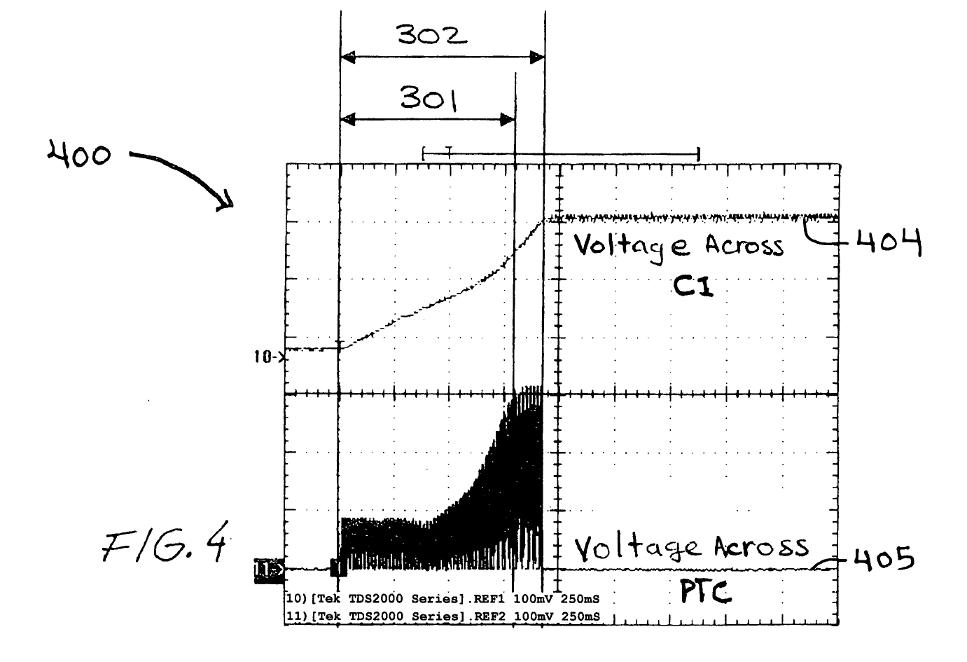

The starting time (TP) (e.g., startup times 301 illustrated in FIGS. 3 and 4) is defined by the characteristics of the PTC thermistor (PTC) 12. As long as the thermistor is not too hot to conduct, and the heat has not disrupted its conduction, current can flow through unless it is cut off by some other mechanism such as the timing circuit (Timer) 14. After the starting time (TP) 301, the timing circuit (Timer) 14 cuts the unidirectional electronic switch (S1) 13, disconnecting the start winding (SW) 22 from the alternating voltage supply source (V1) 4 and leaving only the run winding (RW) 21 connected to the voltage supply source (V1) 4. In steady state (i.e., after startup) the unidirectional electronic switch (S1) 13 is maintained “open”, waiting for a new command from the thermostat (T1) 3.

As described above, the electronic startup device (DP) 1 includes an electronic circuit for startup of single phase induction motors that operates during the starting time (TP) 301 of the motor (M) 2 and turns off afterwards.

The unidirectional electronic switch (S1) 13 may be any semiconductor that has the characteristics of conducting electric current in just one direction and has a control terminal. As such, it may have a multiplicity of constructive forms that include, without limitation: SCR, bipolar transistor, MOSFET transistor, IGBT transistor, or any similar type of semiconductor switch.

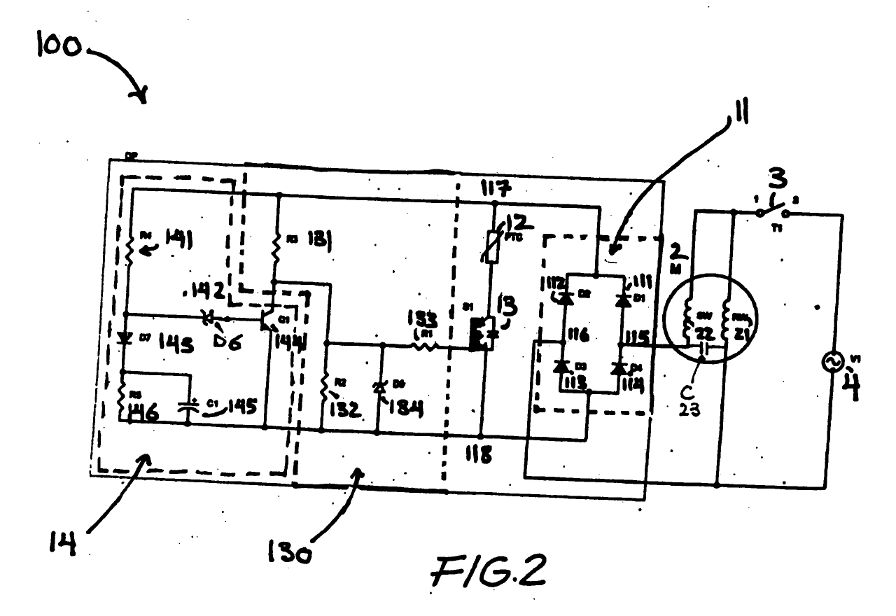

FIG. 2 shows the circuit of FIG. 1 in more detail. The internal circuitry of the rectifier circuit (B1) 11 (delineated by dashed lines), the PTC thermistor (PTC) 12, the unidirectional electronic switch (S1) 13, and the electronic timing circuit (e.g., a Timer) 14 (delineated by a dashed line), all parts of the electronic startup device (DP) 1, are shown in this figure. A trigger circuit or a polarization circuit 130 (delineated by dashed lines) for driving the unidirectional electronic switch (S1) 13 may also be part of the electronic startup device (DP) 1 as shown in this figure.

The rectifier circuit (B1) 11 comprises of diodes (D1) 111, (D2) 112, (D3) 113, and (D4) 114 that together form a full wave rectifier, which transforms an alternating electrical current into a direct current, creating a direct current (DC) bus.

The rectifier circuit (B1) 11 is connected at one input node 115 to the start winding (SW) 22 of the motor (M) 2 and at the other input node 116 to the run winding (RW) 21 and to one of the terminals of the voltage supply source (V1) 4. At the output nodes 117,118, the rectifier circuit (B1) 11 supplies the trigger circuit or the polarization circuit 130 of unidirectional electronic switch (S1) 13 and the electronic timing circuit (Timer) 14.

The PTC thermistor (PTC) 12 is connected in series with the unidirectional electronic switch (S1) 13, the series combination of which is connected in parallel with the rectifier circuit (B1) 11, where the series combination of the PTC thermistor (PTC) 12 and the unidirectional electronic switch (S1) 13 is further connected in series with the start winding (SW) 22 of motor (M) 2. The electronic timing circuit (Timer) 14 turns off the unidirectional electronic switch (S1) 13, thus opening the series circuit composed of the PTC thermistor (PTC) 12, the rectifier circuit (B1) 11, and the start winding (SW) 22 of motor (M) 2.

The polarization circuit 130, which turns on the unidirectional electronic switch (S1) 13 includes resistors (R3) 131 and (R2) 132, which maintain the unidirectional electronic switch (S1) 13 in conduction, thus keeping the PTC thermistor (PTC) 12 connected to the start winding (SW) 22 of motor (M) 2, during the starting time (TP) 301. The resistors (R3) 131 and (R2) 132 form a voltage divider such that the voltage across resistor (R2) 132 is transferred to the unidirectional electronic switch (S1) 13. Another resistor (R1) 133 and a zener diode (D5) 134 may also be used to protect the circuit.

The electronic timing circuit (Timer) 14 includes a resistor (R4) 141, diodes (D6) 142 and (D7) 143, capacitor (C1) 145, and transistor (Q1) 144, which turns off the unidirectional electronic switch (S1) 13 after a turning off time (TD). (e.g., turning off time 302 depicted in FIGS. 3 and 4), thus, disconnecting the series circuit composed of the PTC thermistor (PTC) 12 and the start winding (SW) 22.

In the electronic timing circuit (Timer) 14 the capacitor (C1) 145 is connected in series to a resistor (R4) 141, and this RC system provides the time base for the timer, turning on the transistor (Q1) 144 after the zener voltage of diode (D6) 142 has been exceeded. Turning on the transistor (Q1) 144 implies turning off the unidirectional electronic switch (S1) 13.

The duration of the starting time (TP) 301 is determined by the characteristics of the pill used in the PTC thermistor (PTC) 12. The duration of the turning off time (TD) 302 is determined by the electronic timing circuit (Timer) 14 and is related to the time it takes for the capacitor (C1) 145 of this circuit to recharge to a certain level. Thus, the moment at which the PTC thermistor (PTC) 12 is disconnected from the circuit is determined by the electronic timing circuit (Timer) 14.

The entire circuit, shown in either of the two FIGS. 1 or 2, is energized when the contact of the thermostat (T1) 3 is closed. At that time, the capacitor (C1) 145, within the electronic timing circuit (Timer) 14 is discharged and, with this, transistor (Q1) 144 is cut, opening the circuit across (R2) 132 and causing resistors (R3) 131 and (R2) 132 to form a voltage divider. The voltage across resistor (R2) 132 causes the unidirectional electronic switch (S1) 13 to close and begin conduction.

At this time, the current through the start winding (SW) 22 of motor (M) 2 flows through the rectifier circuit (B1) 11, the PTC thermistor (PTC) 12, and the unidirectional electronic switch (S1) 13. The current-flowing through the PTC thermistor (PTC) 12 will warm up this thermistor causing its electrical resistance to increase which, in turn, causes the current through the start winding (SW) 22 of motor (M) 2 to decrease. The electrical resistance of the PTC thermistor (PTC) 12 will increase until the current through the start winding (SW) 22 of motor (M) 2 is very small, flowing at just the maintenance current level of the PTC thermistor (PTC) 12.

During starting time (TP) 301, capacitor (C1) 145 begins recharging through resistor (R4) 141 and diode (D7) 143. The time constant of the RC circuit is controlled by resistor (R4) 141 and capacitor (C1) 145, where diode (D7) 143 has the function of preventing the capacitor (C1) 145 from discharging through diode (D6) 142. The duration of this time is the turning off time (TD) 302 of the PTC thermistor (PTC) 12. In effect, once the capacitor (C1) 145 is recharged it starts a chain of events as discussed below that leads to the disconnection of the PTC thermistor (PTC) 12 from the circuit and its cooling off. Thus, the time it takes for this capacitor to charge up relates to the time it takes to turn off the thermistor (the turning off time (TD) 302). The turning off time (TD) 302 can be adjusted such that it is shorter than, equal to, or longer than the starting time (TP) 301 (TD<TP, TD=TP, or TD>TP). This may be done by adjusting the time constant of RC circuit mentioned above which determines the turning off time (TD) 302.

Capacitor (C1) 145 will recharge until it reaches the zener voltage of diode (D6) 142. When this occurs, a current will flow through resistor (R4) 141, to diode (D6) 142, and to the base of the transistor (Q1) 144, causing transistor (Q1) 144 to enter into saturation. With transistor (Q1) 144 saturated, the voltage over resistor (R2) 132 is practically zero, thus turning off the unidirectional electronic switch (S1) 13.

When the unidirectional electronic switch (S1) 13 turns off, it eliminates the maintenance current of the PTC thermistor (PTC) 12 and the thermistor begins to cool down. This cooling down enables the resistance through the PTC thermistor (PTC) 12 to go down, allowing for a current through the motor (M) 2 to reestablish in response to a new command by the thermostat (T1) 3 during a new startup.

When the circuit is de-energized through opening of the contact of the thermostat (T1) 3, the capacitor (C1) 145 is discharged through resistor (R5) 146. The re-startup time of the motor (M) 2 is linked to the time required by the capacitor (C1) 145 to discharge.

FIG. 3 and FIG. 4 show typical Waveforms of the current and voltage associated with one embodiment of an electronic startup device (DP) 1 and its encompassing system 100. These figures show the startup time (TP) 301 and the turning off time (TD) 302 and further describe the basic operation of the electronic startup device (DP) 1 and system 100.

FIG. 3 shows the buildup of voltage 304 across the capacitor (C1) 145 and the contemporaneous drop of current 303 in the start winding (SW) 22 during starting time (TP) 301. As seen on FIG. 3, once the capacitor (C1) 145 is fully charged, the circuit reaches its turning off time (TD) 302 and the current 303 flowing in the start winding (SW) 22 diminishes.

FIG. 4 shows the buildup of voltage 304 across the capacitor (C1) 145 and the contemporaneous buildup of voltage 305 across the PTC thermistor (PTC) 12 during starting time (TP) 301. As seen on FIG. 4, once the capacitor (C1) 145 is fully charged, the voltage across the PTC thermistor (PTC) 12 reaches its maximum. After the turning off time (TD) 302, current flow through the PTC thermistor (PTC) 12 ceases and, because the circuit is now open, the voltage across the PTC thermistor (PTC) 12 drops to zero.

One aspect of the electronic startup device (DP) 1 of the present invention is related to energy consumption in single phase induction motors. That is, after starting time (TP) 301, the energy consumption of a system encompassing the electronic startup device (DP) 1, such as system 100, may be significantly smaller than that of conventional systems that use only the PTC thermistor (PTC) 12 comprising of a solid state chip with a positive temperature coefficient.

Another aspect of the electronic startup device (DP) 1 of this invention is that the greater the supply voltage of the voltage source (V1) 4, the shorter the disconnection time for the PTC thermistor (PTC) 12 and vice versa. That is, in situations where the supply voltage of the voltage source (V1) 4 is smaller, the disconnection time will be longer, because the PTC thermistor (PTC) 12 will take more time to warm up. The startup of the motor (M) 2 may be assured, because the PTC thermistor (PTC) 12 is disconnected only after startup has occurred and a current begins to flow through the thermistor.

Yet another characteristic of the electronic startup device (DP) 1 of this invention may be the use of a unidirectional electronic switch, such as the unidirectional electronic switch (S1) 13. This unidirectional electronic switch may be, for example, a SCR, a bipolar transistor, a MOSFET type transistor, an IGBT type transistor, and others that can be used for the control of the PTC thermistor (PTC) 12 and, consequently, for the control of the circuit of the electronic startup device (DP) 1.

Further, the electronic startup device (DP) 1 of this invention may be used with start capacitors or with permanent capacitors. Moreover, the electronic startup device (DP) 1 of this invention may use relatively few components, thus facilitating production and assuring reduced dimensions.

What is claimed is:

1. An electronic startup device for startup of single phase induction motors, the electronic startup device operating only during a starting time of the motor, comprising:
a rectifier circuit for transforming an alternating electrical signal into a direct electrical signal, creating a direct current (DC) bus;
a unidirectional electronic switch;
a thermistor, with a positive temperature coefficient, in series with the unidirectional electronic switch forming a first series circuit, the first series circuit coupled in parallel with the direct current DC bus, wherein the first series circuit is further in series with a start winding of the motor forming a second series circuit;
a polarization circuit, for turning on the unidirectional electronic switch; and
an electronic timing circuit, for turning off the unidirectional electronic switch thereby uncoupling the second series circuit.

2. The electronic startup device of claim 1, wherein the polarization circuit comprises:
a first and a second resistor for maintaining the unidirectional electronic switch in conduction during a starting time, by keeping the thermistor coupled to the start winding of the motor during the starting time.

3. The electronic startup device of claim 1, wherein the electronic timing circuit comprises:
a resistor;
a first diode and a second diode;
a capacitor; and
a transistor for turning off the unidirectional electronic switch after a determined period of turning off time.

4. The electronic startup device of claim 1, wherein the unidirectional electronic switch is a device having a control terminal and is capable of conducting electric current in only one direction.

5. A startup device for startup of an induction motor, the startup device comprising:
a thermistor adapted to be coupled to a start winding of the induction motor and configured to variably reduce the current through the start winding during startup of the induction motor;
a switch adapted to be coupled to a start winding and configured to enable or disable current flow through the start winding in accordance with a control signal; and
a timer for generating the control signal.

6. The startup device of claim 5 wherein the switch comprises a unidirectional electronic switch.

7. The startup device of claim 5 comprising a resistor network configured to biasing the control signal during the startup of the induction motor such that the switch enables current flow through the start winding.

8. The startup device of claim 5 wherein the timing circuit comprises a resistor and capacitor network configured to generate a timing signal that modifies the control signal to cause the switch to disable current flow through the start winding.

9. The startup device of claim 5 comprising a transistor coupled to receive the timing signals and configured to generate the control signal.

10. A method of controlling startup of an induction motor, the method comprising:
initiating startup of the induction motor;
providing a current path through a start winding of the induction motor, a thermistor and a switch;
reducing, by the thermistor, current flow in the current path during startup of the induction motor;
providing a control signal to control the switch to disable current flow through the start winding after the induction motor has started.

11. The method of claim 10 wherein the control signal is provided by a timer.

12. The method of claim 10 wherein the switch comprises a unidirectional electronic switch.
